(19) United States
(12) Patent Application Publication
(10) Pub. No.: US 2024/0267976 A1
(43) Pub. Date: Aug. 8, 2024

(54) Performing Mobile Terminated Small Data Transmission (MT-SDT) in a Wireless Network

(71) Applicant: Apple Inc., Cupertino, CA (US)

(72) Inventors: Fangli Xu, Beijing (CN); Haijing Hu, Los Gatos, CA (US); Naveen Kumar R. PALLE VENKATA, San Diego, CA (US); Peng Cheng, Beijing (CN); Ping-Heng Kuo, London (GB); Ralf Rossbach, Munich (DE); Yuqin Chen, Beijing (CN)

(21) Appl. No.: 18/431,839

(22) Filed: Feb. 2, 2024

Related U.S. Application Data
(60) Provisional application No. 63/443,309, filed on Feb. 3, 2023.

(51) Int. Cl. H04W 76/20; H04B 17/318; H04W 68/02; H04W 74/0833

(52) U.S. Cl. CPC H04W 76/20; H04B 17/328; H04W 68/02; H04W 74/0833

(57) ABSTRACT

Disclosed are methods, systems, and computer-readable medium to perform operations including receiving, in an RRC_INACTIVE state, a paging message from a base station of a wireless network, the paging messaging including a Mobile Terminated Small Data Transmission (MT-SDT) indication; determining whether one or more conditions for exchanging data with the base station using MT-SDT are satisfied; and transmitting, in the RRC_INACTIVE state, an uplink (UL) response message to initiate the MT-SDT, based on a determination that the one or more conditions are satisfied.

### CROSS-REFERENCE TO RELATED APPLICATION

This application claims priority to U.S. Provisional Patent Application No. 63/443,309, filed Feb. 3, 2023, the entire contents of which are incorporated herein by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP).

### SUMMARY

In accordance with one aspect of the present disclosure, a method includes receiving, by a user equipment (UE) in an RRC_INACTIVE state, a Mobile Terminated Small Data Transmission (MT-SDT) paging message from a base station of a wireless network; determining, by the UE, whether one or more conditions for transferring data from the base station to the UE using MT-SDT have been configured; and performing at least one of: (i) upon determining that the one or more conditions have not been configured, transmitting, by the UE, an uplink (UL) response message to the base station indicating an initiation of MT-SDT, and receiving, by the UE, data from the base station using MT-SDT, (ii) upon determining that the one or more conditions have been configured and that the one or more configured conditions have been satisfied, transmitting, by the UE, the UL response message to the base station indicating the initiation of MT-SDT, and receiving, by the UE, data from the base station using MT-SDT, or (iii) upon determining that the one or more conditions have been configured and that at least one of the one or more configured conditions has not been satisfied, receiving, by the UE, data from the base station in an RRC_CONNECTED state.

Implementations of this aspect can include one or more of the following features.

In some implementations, the one or more conditions can include a first condition pertaining to a radio quality of wireless signals received by the UE from the base station.

In some implementations, the first condition is satisfied when a Reference Signal Received Power (RSRP) of the wireless signals is greater than a threshold value.

In some implementations, the first condition can be configured for both MT-SDT and Mobile Originated Small Data Transmission (MO-SDT).

In some implementations, the one or more conditions can include a second condition pertaining to at least one of a radio bearer or a radio service for exchange data between the base station and the UE.

In some implementations, the second condition is satisfied upon the UE determining that one or more resource blocks (RBs) indicated by the base station are configured for MT-SDT.

In some implementations, the one or more conditions can include a third condition pertaining to a selection of a resource for transmitting the UL response message from the UE to the base station.

In some implementations, the third condition can include selecting the resource from among: a legacy Random Access Channel (RACH) resource, a RACH resource specific to Small Data Transmission (SDT), and a Configured Grant (CG) resource specific to SDT.

In some implementations, the legacy RACH resource can be selected, and the legacy RACH resource can be different from one or more RACH resources specific to SDT.

In some implementations, the one or more conditions can be configured based on an RRC Release message transmitted from the base station to the UE.

In some implementations, the one or more conditions can be configured based on the MT-SDT paging message.

In some implementations, the method can be performed by a user equipment (UE).

In some implementations, the method can be performed by at least one baseband processor.

In another aspect, a method includes receiving, by a base station of a wireless network, data for transmission to a user equipment (UE), where the UE is in an RRC_INACTIVE state; transmitting, by the base station to the UE, a Mobile Terminated Small Data Transmission (MT-SDT) paging message; and performing at least one of: upon receiving an uplink (UL) response message indicating an initiation of MT-SDT by the UE, transmitting the data to the UE using MT-SDT, or upon determining that the UE entered an RRC_CONNECTED State, transmitting the data to the UE in the RRC_CONNECTED state.

Implementations of this aspect can include one or more of the following features.

In some implementations, the method can further include transmitting, by the base station to the UE configuration information representing one or more conditions for transferring the data from the base station to the UE using MT-SDT.

In some implementations, at least a portion of the configuration information can be transmitted from the base station to the UE via an RRC Release message.

In some implementations, at least a portion of the configuration information can be transmitted from the base station to the UE via the MT-SDT paging message.

In some implementations, the one or more conditions can include a first condition pertaining to a radio quality of wireless signals received by the UE from the base station.

In some implementations, the first condition is satisfied when a Reference Signal Received Power (RSRP) of the wireless signals is greater than a threshold value.

In some implementations, the first condition can be configured for both MT-SDT and Mobile Originated Small Data Transmission (MO-SDT).

In some implementations, the one or more conditions can include a second condition pertaining to at least one of a radio bearer or a radio service for transmitting data between the base station and the UE.

In some implementations, the second condition is satisfied upon the UE determining that one or more resource blocks (RBs) indicated by the base station are configured for MT-SDT.

In some implementations, one or more conditions can include a third condition pertaining to a selection of a resource for transmitting the UL response message from the UE to the base station.

In some implementations, the third condition can include selecting the resource from among: a legacy Random Access Channel (RACH) resource, a RACH resource specific to Small Data Transmission (SDT), and a Configured Grant (CG) resource specific to SDT.

In some implementations, the legacy RACH resource can be selected, and the legacy RACH resource can be different from one or more RACH resources specific to SDT.

In some implementations, the base station can transmit the MT-SDT paging message responsive to: determining a resource block (RB) associated with the data for transmission to the UE, and determining that the RB is configured for MT-SDT.

In some implementations, the method can be performed by a base station.

In some implementations, the method can be performed by at least one baseband processor.

In another aspect, an apparatus includes one or more one or more processors and one or more storage devices on which are stored instructions that are operable, when executed by the one or more processors, to cause the one or more processors to perform any of the operations described herein.

In some implementations, the apparatus can be a UE.

In some implementations, the apparatus can be a base station.

In some implementations, the apparatus can be a baseband processor.

In another aspect, a method includes: receiving, in an RRC_INACTIVE state, a paging message from a base station of a wireless network, the paging messaging including a Mobile Terminated Small Data Transmission (MT-SDT) indication; determining whether one or more conditions for exchanging data with the base station using MT-SDT are satisfied; and transmitting, in the RRC_INACTIVE state, an uplink (UL) response message to initiate the MT-SDT, based on a determination that the one or more conditions are satisfied.

Implementations of this aspect can include one or more of the following features.

In some implementations, the one or more conditions can include a first condition pertaining to a radio quality of wireless signals received from the base station.

In some implementations, the first condition can be satisfied when a Reference Signal Received Power (RSRP) of the wireless signals is greater than a threshold value.

In some implementations, the first condition can be configured for both MT-SDT and Mobile Originated Small Data Transmission (MO-SDT).

In some implementations, the one or more conditions can include a second condition pertaining to a selection of a resource for transmitting the UL response message to the base station.

In some implementations, the second condition can include selecting the resource from among: a legacy Random Access Channel (RACH) resource, a RACH resource specific to Small Data Transmission (SDT), and a Configured Grant (CG) resource specific to SDT.

In some implementations, the legacy RACH resource can be selected, and the legacy RACH resource can be different from one or more RACH resources specific to SDT.

In some implementations, the method can include: determining that the first condition is not satisfied, and responsive to determining that the first conditions is not satisfied, initiating an RRC Resume procedure.

In some implementations, the UL response message can be transmitted using one or more resources selected based on a configuration received from the base station.

In some implementations, the configuration received from the base station can be a RRC specific configuration.

In some implementations, the configuration received from the base station can be a System Information Block (SIB) broadcast configuration.

In some implementations, the method can be performed by a user equipment (UE).

In another aspect, a method includes: transmitting, to the UE in an RRC-INACTIVE state, a paging message including a Mobile Terminated Small Data Transmission (MT-SDT) indication; and receiving, from the UE in the RRC-INACTIVE state, an uplink (UL) response message initiating the MT-SDT, based on one or more conditions for exchanging data with the UE using the MT-SDT being satisfied.

Implementations of this aspect can include one or more of the following features.

In some implementations, the one or more conditions can include a first condition pertaining to a radio quality of wireless signals received by the UE.

In some implementations, the first condition can be satisfied when a Reference Signal Received Power (RSRP) of the wireless signals is greater than a threshold value.

In some implementations, the first condition can be configured for both MT-SDT and Mobile Originated Small Data Transmission (MO-SDT).

In some implementations, the one or more conditions can include a second condition pertaining to a selection of a resource by the EU for transmitting the UL response message.

In some implementations, the second condition can include selecting the resource from among: a legacy Random Access Channel (RACH) resource, a RACH resource specific to Small Data Transmission (SDT), and a Configured Grant (CG) resource specific to SDT.

In some implementations, the legacy RACH resource can be selected by the UE, and the legacy RACH resource can be different from one or more RACH resources specific to SDT.

In some implementations, the method can include: receiving data for transmission to the UE, and transmitting the data to the UE using MT-SDT.

In some implementations, the method can be performed by a base station.

In some implementations, the method can be performed by at least one baseband processor.

In another aspect, a method includes any of the any of the operations described herein.

In another aspect, one or more baseband processors can be configured to perform any of the operations(s) described herein.

In another aspect, a non-transitory computer storage medium is encoded with instructions that, when executed by one or more processors, cause the one or more processors to perform any of the operations(s) described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network.

FIG. 2 illustrates an example process for initiating and Mobile Terminated Small Data Transmission (MT-SDT) between a user equipment (UE) and the base station.

FIG. 3 illustrates an example process for determining whether to trigger MT-SDT by a UE.

FIGS. 4A-4D illustrate flowcharts of example methods.

FIG. 5 illustrates an example UE.

FIG. 6 illustrates an example access node.

### DETAILED DESCRIPTION

This disclosure sets forth various techniques for facilitating Mobile Terminated Small Data Transmission (MT-SDT) in a wireless network, such as a cellular network.

In an example implementation, a base station of a wireless network transmits a paging message (e.g., a MT-SDT paging message) to a user equipment (UE) indicating that data can be transmitted from the base station to the UE according to MT-SDT. Upon receiving the paging message, the UE determines whether to receive the data from the base station according to MT-SDT, or to instead receive the data from the base station according to a legacy process. In some implementations, the UE can make this determination based on one or more conditions specified by the wireless network (e.g., one or more conditions indicated in configuration information transmitted to the UE from the base station) and/or based on other considerations.

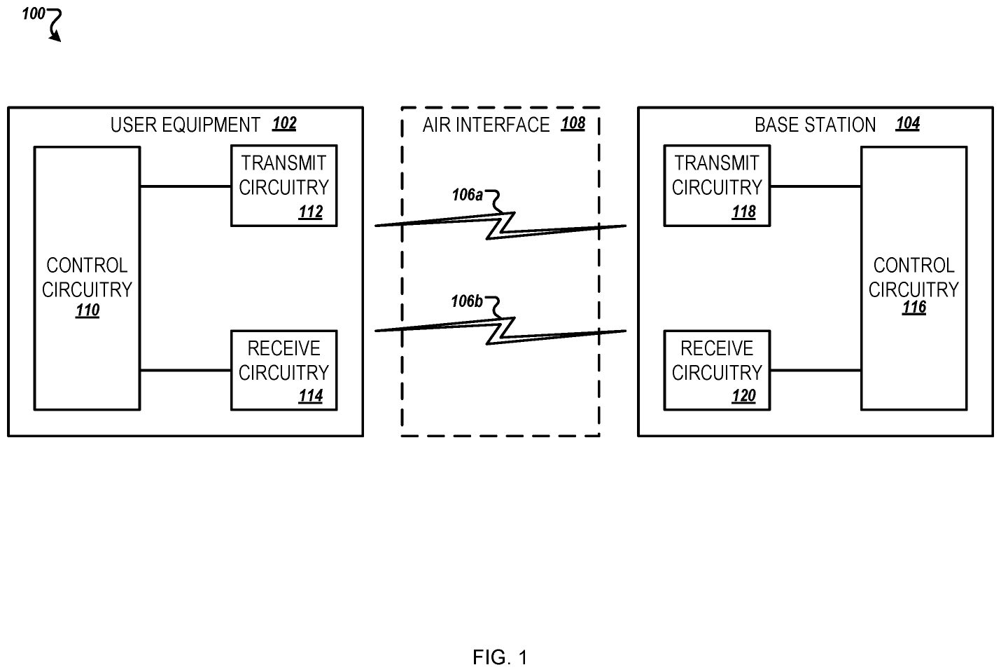

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

In some implementations, the UE 102 and the base station 104 can exchange data with one another according to a legacy data transmission procedure, whereby the UE 102 is in a Radio Resource Control (RRC) “connected” state (e.g., “RRC_CONNECTED” state) when transmitting data to and/or receiving data from the base station 104. For example, the UE 102 can initially be in an RRC “idle” or “inactive” state (e.g., “RRC_IDLE” state or “RRC_INACTIVE” state). Upon determining that data is to be transferred from the base station 104 to the UE 102 according to a legacy data transmission procedure, the UE 102 can transition to the RRC_CONNECTED state and receive the data from the UE 102 while in the RRC_CONNECTED state. Similarly, upon determining that data is to be transferred from the UE 102 to the base station 104 according to a legacy data transmission procedure, the UE 102 can likewise transition to the RRC_CONNECTED state and transmit the data to the base station 104 while in the RRC_CONNECTED state. Upon completion of the data exchange, the UE 102 can remain in the RRC_CONNECTED state, or transition back to the RRC_IDLE state or RRC_INACTIVE state (e.g., upon being released back into the RRC_IDLE state or RRC_INACTIVE state by the base station 104).

In some implementations, the UE 102 and the base station 104 can exchange data with one another according to a Small Data Transmission (SDT) procedure, whereby the UE 102 is in the RRC_INACTIVE state when transmitting data to and/or receiving data from the base station 104. For example, the UE 102 can initially be in the RRC_INACTIVE state. Upon determining that data is to be transferred from the base station 104 to the UE 102 according to a SDT procedure, the UE 102 can remain in the RRC_INACTIVE and receive the data from the UE 102 (e.g., without transitioning into the RRC_CONNECTED state). Similarly, upon determining that data is to be transferred from the UE 102 to the base station 104 according to a SDT procedure, the UE 102 can likewise remain in the RRC_INACTIVE and transmit the data to the base station 104 (e.g., without transitioning into the RRC_CONNECTED state).

In some implementations, a SDT session that begins with the transmission of data from the UE 102 to the base station 104 (e.g., uplink data transmission) may be referred to as Mobile Originated Small Data Transmission (MO-SDT). For example, upon receiving data for transmission to the base station 104, the UE 102 can trigger MO-SDT, and transmit the data to the base station 104 in an RRC_INACTIVE state. Subsequently, the UE 102 and the base station 104 can exchange further additional and/or uplink data using SDT.

In some implementations, a SDT session that begins with the transmission of data from the base station 104 to the UE 102 to the base station 104 using (e.g., downlink data transmission) may be referred to as Mobile Terminated Small Data Transmission (MT-SDT). For example, upon receiving data for transmission to the UE 102, the base station 104 can trigger MO-SDT, and transmit the data to the UE 102 while the UE 102 is in an RRC_INACTIVE state. Subsequently, the UE 102 and the base station 104 can exchange downlink and/or uplink data using SDT.

Data transmission using SDT can be beneficial, for example, in enabling data to be exchanged between the UE 102 and the base station 104 in a more efficient manner (e.g., compared to data transmission without the use of SDT, such as in an RRC_CONNECTED state). For example, certain resources (e.g., network resources, computation resources, memory resources, etc.) may be expended by the UE 102 and/or the base station 104 in transitioning and/or maintaining the UE 102 in a RRC_CONNECTED state. This resource overhead can be eliminated or otherwise reduced by transmitting exchanging data using SDT instead (e.g., by avoiding or otherwise reducing the frequency by which the UE 102 operates in an RRC_CONNECTED state).

In some implementations, resources can be include resources in the network physical layer (e.g., “PHY”) in the time domain/frequency domain, the code domain, or a combination thereof.

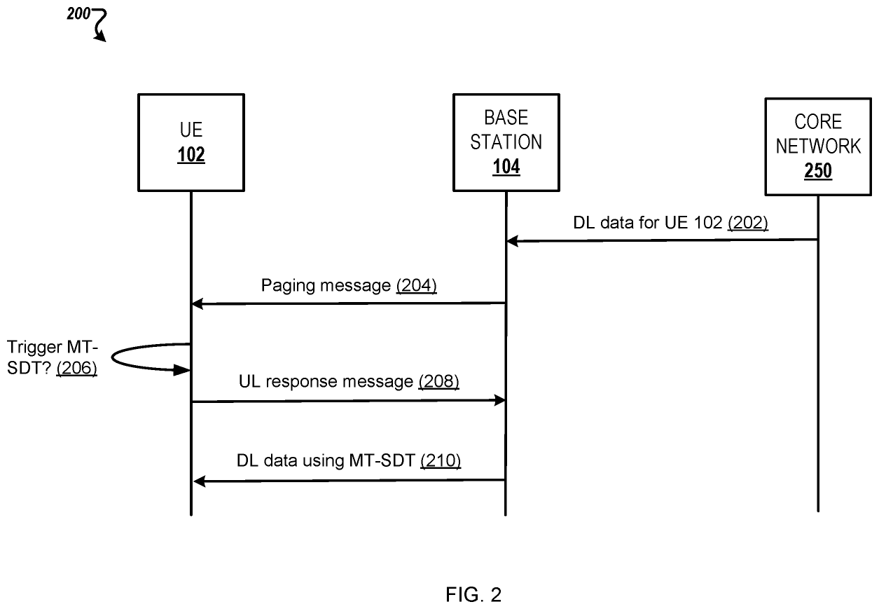

FIG. 2 shows an example process 200 for initiating and performing SDT (e.g., MT-SDT) between the UE 102 and the base station 104.

According to the process 200, the base station 104 receives downlink data intended for transmission to the UE 102 (202). As an example, the downlink data can be received from a Core Network (CN) of a wireless network. In some implementations, the downlink data can be data provided to the CN by another device or system of the wireless network (e.g., another UE, base station, or any other system or device of the wireless network) for delivery to the UE 102.

Upon receiving the downlink data, the base station 104 identifies the corresponding UE 102 (e.g., the intended recipient of the downlink data), and transmits a paging message to the UE 102 (204). The paging message indicates that data is available for transmission from the base station 104 to the UE 102, and that the data can transmitted via MT-SDT. In some implementations, the paging message may be referred to as a MT-SDT paging message. In some implementations, the UE 102 can receive the paging message 204 while in a RRC_INACTIVE or RRC_IDLE state.

Upon receiving the paging message, the UE 102 determines whether to initiate (or “trigger”) MT-SDT (206). In some implementations, the UE can make this determination based on one or more conditions specified by the wireless network (e.g., one or more conditions indicated in configuration information transmitted to the UE 102 from the base station 104) and/or based on other considerations. Example processes for determining whether to trigger MT-SDT are described in further detail below.

If the UE 102 determines that MT-SDT should be triggered, the UE 102 transmits an uplink response message to the base station 104, as shown in FIG. 2 (208). As an example, the uplink response message can indicate that the UE 102 is available to receive data using MT-SDT (e.g., while the UE 102 is an RRC_INACTIVE state). In some implementations, the uplink response message can indicate one or more network resources that are available for receiving the data using MT-SDT. Further, the UE 102 performs a MT-SDT procedure in preparation for receiving data from the base station 104. As a part of the MT-SDT procedure, the UE 102 can transition to (or remain in) a RRC_INACTIVE state.

Upon receiving the uplink resource message, the base station 104 transmits the downlink data to the UE 102 using MT-SDT (210). During the transmission of the downlink data, the UE 102 can remain in an RRC_INACTIVE state (e.g., rather than transitioning into a RRC_CONNECTED state).

Alternatively, if the UE 102 determines that MT-SDT should not be triggered, the UE 102 initiates the reception of data using a legacy process (not shown in FIG. 2). As an example, the UE 102 can transition to a RRC_CONNECTED state (e.g., by performing a RRC Resume procedure), and receive the downlink data from the base station 104 while in the RRC_CONNECTED state. Further, upon completion of the data exchange, the UE 102 can remain in the RRC_CONNECTED state, or transition back to a RRC_IDLE state or RRC_INACTIVE state (e.g., upon being released into the RRC_IDLE state or RRC_INACTIVE state by the base station 104).

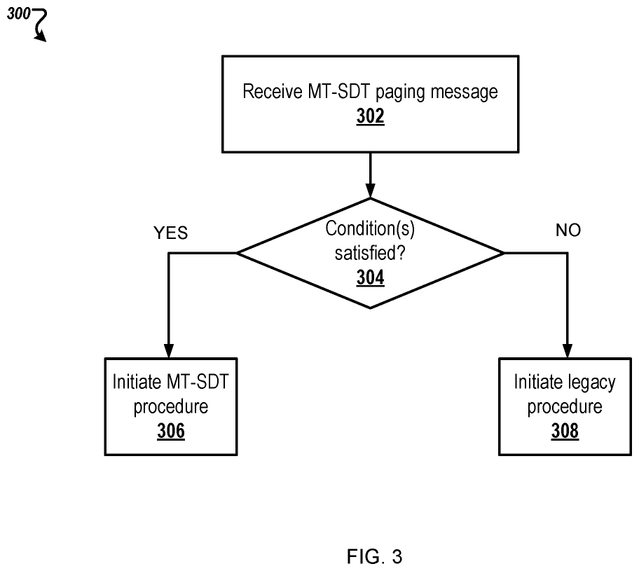

FIG. 3 shows an example process 300 for determining whether to trigger MT-SDT by the UE 102 (e.g., in connection with 206 of FIG. 2).

According to the process 300, the UE 102 receives a paging message (e.g., a MT-SDT paging message) from the base station 104 (block 302). This process can be similar to that described with reference to block 204 of FIG. 2.

Upon receiving the paging message, the UE 102 determines whether any conditions have been configured regarding the receipt of data using MT-SDT, and if so, whether those condition(s) have been satisfied (block 304). In some implementations, at least one of the condition(s) can pertain to a radio quality of wireless signals received by the UE 102 from the base station 104. In some implementations, at least one of the condition(s) can pertain to a radio bearer and/or a radio service for transmitting data between the base station 104 and the UE 102. In some implementations, at least one of the condition(s) can pertain to a selection of a resource for transmitting an uplink response message from the UE 102 to the base station 104. Example conditions are described in further detail below.

In some implementations, at least some of the condition(s) can be specified in configuration information transmitted to the UE 102 from the base station 104. For example, at least some of the condition(s) can be signaled by the base station 104 to the UE 102 via RRC signal (e.g., via an RRCRelease message transmitted from the base station 104 to the UE 102). As another example, at least some of the condition(s) can be signaled by the base station 104 to the UE 102 in a paging message (e.g., the MT-SDT paging message) transmitted from the base station 104 to the UE 102.

Upon determining that all of the condition(s) are satisfied, the UE 102 initiates a MT-SDT procedure for receiving data from the base station 102 (block 306). For example, as described with reference to FIG. 2, the UE 102 can transmit an uplink response message to the base station 102 to indicate that the UE 102 is available to receive data using MT-SDT. Further, the UE 102 can remain (or transition to) a RRC_INACTIVE state to receive the data using MT-SDT.

Alternatively, upon determining that at least one of the condition(s) is not satisfied, the UE 102 initiates a legacy procedure for receiving data from the base station 102 (block 308). For example, as described with reference to FIG. 2, the UE 102 can transition to a RRC_CONNECTED state (e.g., by performing a RRC Resume procedure), and receive the downlink data from the base station while in in the RRC_CONNECTED state.

As described above, the UE 102 can determine whether to trigger MT-SDT based on one or more conditions. Example conditions and operation are described in further detail below.

### Example Radio Quality Condition

In some implementations, at least one of the condition(s) can pertain to a radio quality of wireless signals received by the UE 102 from the base station 104.

As an example, a condition can specify that the UE 102 can initiate MT-SDT when the Reference Signal Received Power (RSRP) of wireless signals received from the base station 104 is greater than a threshold value (e.g., RSRP>RSRP_{threshold}). As another example, a condition can specify that the UE 102 can initiate MT-SDT when the Reference Signal Received Power (RSRP) of wireless signals received from the base station 104 is greater than or equal to a threshold value (e.g., RSRP≥RSRP_{threshold}).

In some implementations, if a condition regarding radio quality is not configured (e.g., none of the configuration specify a radio quality condition for initiating MT-SDT), the UE 102 can assume that such a condition is satisfied, and initiate MT-SDT so long as the remaining conditions (if any) are satisfied. Further, the UE 102 can select a resource for transmitting an uplink response message to the base station 104 and/or receiving data via MT-SDT using a legacy Random Access Channel (RACH) procedure. For instance, the UE 102 can select a legacy Random Access (RA) resource for transmitting the uplink response message to the base station 104 and/or receiving data via MT-SDT.

### Example Radio Quality Condition

In some implementations, at least one of the condition(s) can pertain to a radio bearer and/or a radio service for transmitting data between the base station 104 and the UE 102.

As an example, in some implementations, the base station 104 can trigger MT-SDT paging to the UE 102 only when downlink data arrives for a MT-SDT resource block (MT-SDT-RB). The base station 104 can signal the MT-SDT-RB to the UE 102 using various techniques. For example, the base station 104 can configure the MT-SDT-RB to the UE 102 via an RRCRelease with SuspendConfig message. As another example, the base station 104 can inform the UE 102 of the MT-SDT-RB via the MT-SDT paging message. As another example, the base station 104 can both (i) configure the MT-SDT-RB to the UE 102 via an RRCRelease with SuspendConfig message and (ii) inform the UE 102 of the MT-SDT-RB via the MT-SDT paging message.

In implementations in which the base station 104 configures the MT-SDT-RB to the UE 102 via an RRCRelease with SuspendConfig message only, the UE 102 can initiate MT-SDT upon receiving the MT-SDT paging message (assuming that all of the other conditions are satisfied). When the UE 102 initiates the MT-SDT procedure, the UE 102 can reestablish and resume the indicated MT-SDT-RB(s) for MT-SDT data reception.

In implementations in which the base station 104 informs the UE 102 of the MT-SDT-RB via the MT-SDT paging message only, the UE 102 can initiate MT-SDT upon receiving the MT-SDT paging message (assuming that all of the other conditions are satisfied). When the UE 102 initiates the MT-SDT procedure, the UE 102 can reestablish and resume the indicated MT-SDT-RB(s) for MT-SDT data reception.

In implementations, in which the base station both (i) configures the MT-SDT-RB to the UE 102 via an RRCRelease with SuspendConfig message and (ii) informs the UE 102 of the MT-SDT-RB via the MT-SDT paging message, upon receiving the MT-SDT paging message, the UE 102 initially checks whether the indicated RB is configured for MT-SDT-RB. If the indicated RB is not the configured MT-SDT-RB or MT-SDT paging message does not include the RB information, UE initiates the legacy RRC Resume procedure. Otherwise, UE 102 initiates the MT-SDT procedure, and resumes the MT-SDT RB for MT-SDT data reception. When resuming the MT-SDT RB for MT-SDT data reception, the UE 102 can either (i) resumes the indicated RB, or (ii) resume all the configured MT-SDT RBs.

In at least some implementations, if UE 102 receives data indicating an RB that is not in the set of configured MT-SDT-RBs, the UE 102 can assume that a failure occurred in MT-SDT process, and transition to an RRC_IDLE state.

### Example Radio Quality Condition

In some implementations, at least one of the condition(s) can pertain to a selection of a resource for transmitting an uplink response message from the UE 102 to the base station 104.

In general, a UE 102 can select from among different resources for transmitting the uplink response message to the base station 104. Example resources include a legacy RACH resource, a SDT-specific RACH resource (SDT-RA), and/or a SDT specific Configured Grant (CG) resource (SDT-CG).

In some implementations, a condition can specify a procedure for selecting between different RA types based on radio quality. As an example, a condition can specify that if the radio quality is greater than a threshold value (e.g., RSRP>RSRP_{threshold}) and/or greater than or equal to a threshold value (e.g., RSRP>RSRP_{threshold}, the UE 102 is to select a SDT-specific RA resource. As another example, a condition can specify that if the radio quality is less than a threshold value (e.g., RSRP<RSRP_{threshold}), the UE 102 is to select a legacy RA resource. As another example, a condition can specify that if the radio quality is less than a threshold value (e.g., RSRP<RSRP_{threshold}), the UE 102 is to assume that no available RACH resources can be used for MT-SDT.

In some implementations, a radio quality condition can be configured per resource type. For example, the UE 102 can be configured to select a particular resource type when a radio quality for that resource type is satisfied. If the conditions for more than one resource type are satisfied, the UE 102 can select the resource type by implementation or according to the predefined/configured rule. For example, the UE 102 can select the resource type according to a particular priority (e.g., SDT-RA resources having the highest priority, followed by SDT-RA resources, followed by legacy RA sources). As another example, the UE 102 can assume that no available RACH resources can be used for MT-SDT.

In some implementations, a resource can be selected based on conditions pertaining to radio bearer. For example, the base station 104 can configure, to the UE 102, an association between (i) one or more MT-SDT-RBs and (ii) particular resource(s) and/or resource type(s). If UE 102 can acquire the MT-SDT-RB information from MT-SDT paging, the UE 102 can select the indicated resources and/or resource types accordingly.

### Additional Example Conditions

In some implementations, at least one of the condition(s) can pertain to configuring MT-SDT and MO-SDT concurrently.

In some implementations, the same conditions can be shared for both MT-SDT and MO-SDT.

As an example, at least one condition can specify a radio quality threshold for SDT (e.g., both MT-SDT and MO-SDT), such as a threshold regarding RSRP (e.g., as described above).

As another example, at least one condition can specify that only certain radio bearers are permitted for SDT transmission (e.g., both MT-SDT and MO-SDT).

As another example, at least one condition can specify SDT-RA and/or CG-SDT resource selection for SDT transmission (e.g., both MT-SDT and MO-SDT).

In some implementations, certain conditions may be applicable to MO-SDT only. For example, at least one condition can specify a SDT data amount threshold, e.g., the amount of data to be transferred should be below a particular threshold amount to trigger MO-SDT.

In some implementations, certain conditions may be applicable to MT-SDT only. For example, at least one condition can specify that a legacy RA resource is selected for UL response transmission.

Although example conditions are described individually herein, in practice, any condition can be implemented either individually or in combination with one or more other conditions. Further, other conditions also can be implemented, either in addition to or instead of those described herein.

### Example Methods:

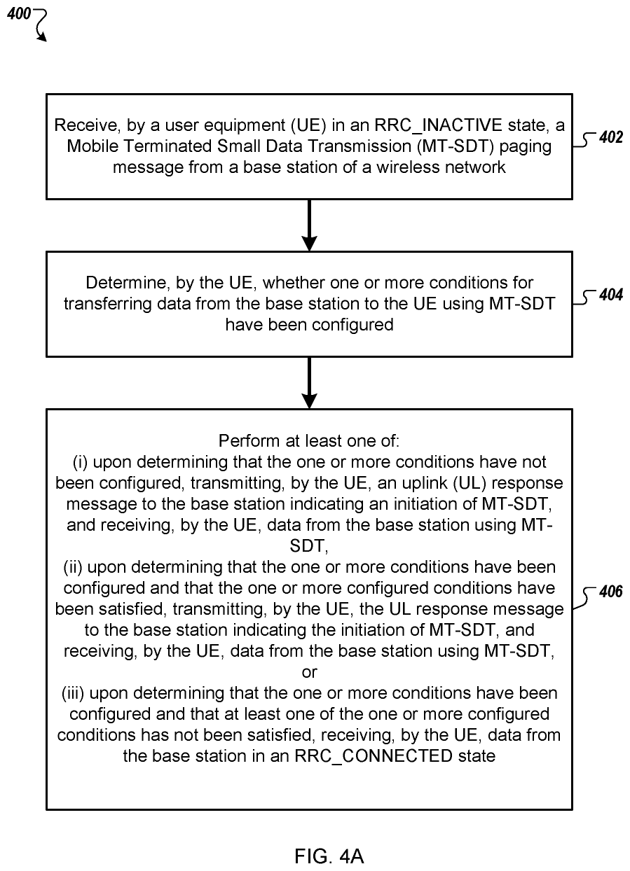

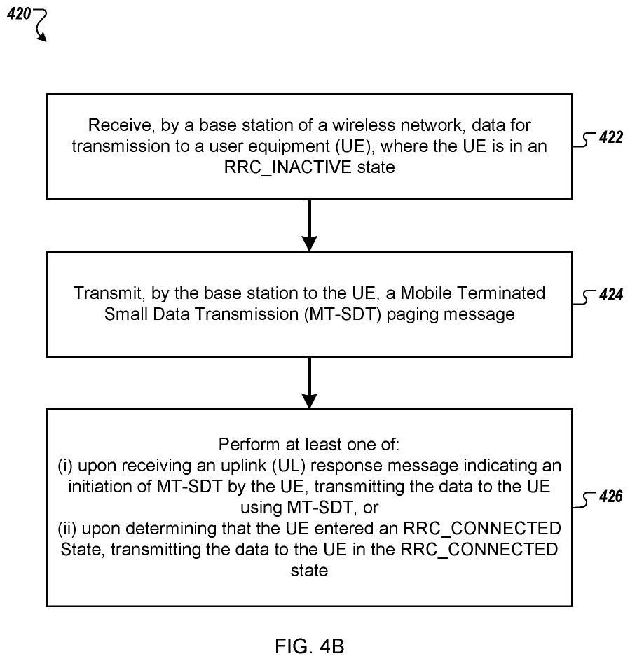

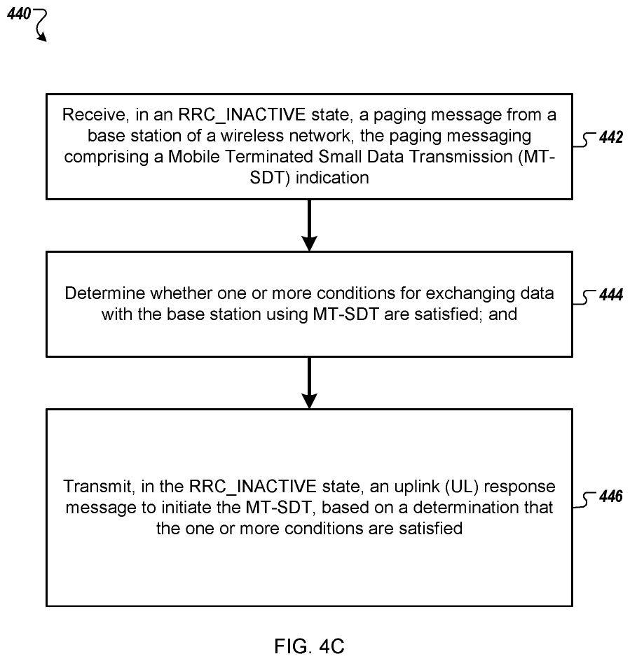

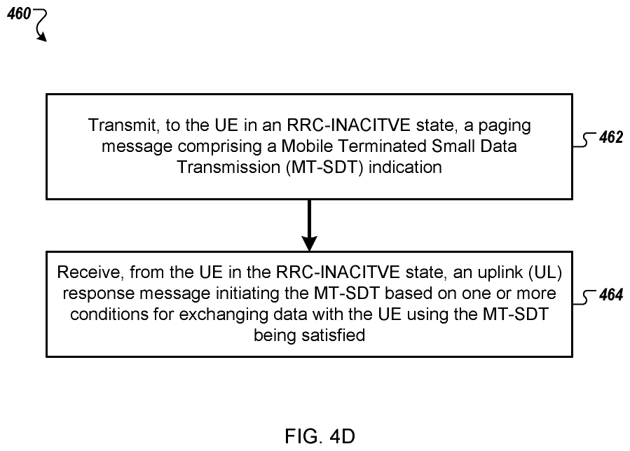

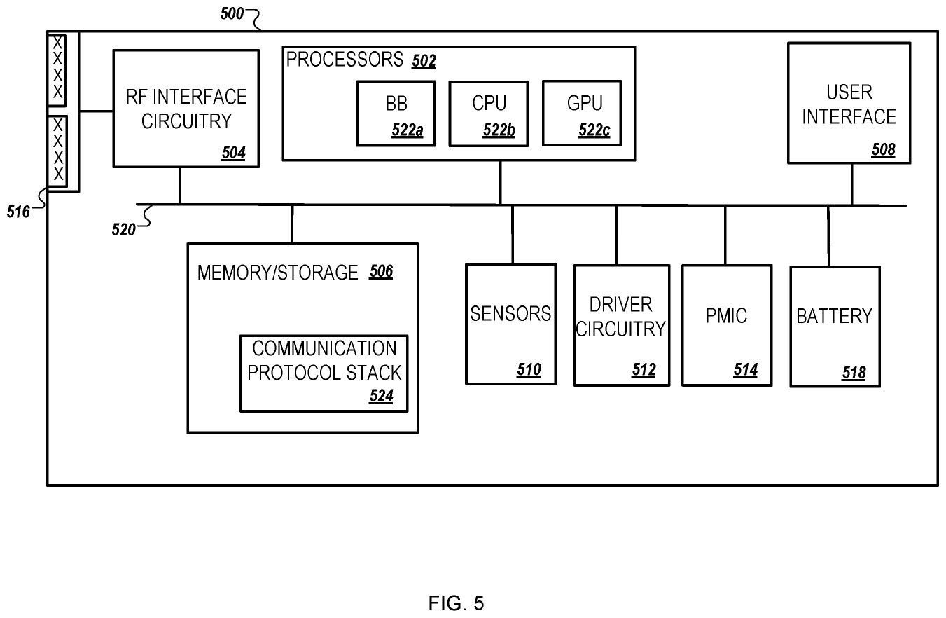

FIG. 4A illustrates a flowchart of an example method 400. For clarity of presentation, the description that follows generally describes method 400 in the context of the other figures in this description. For example, method 400 can be performed, at least in part, by the UE 102 and/or UE 500 shown in FIGS. 1 and 5, respectively. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

According to the method 400, a UE receives, in an RRC_INACTIVE state, a MT-SDT paging message from a base station of a wireless network (block 402).

Further, the UE determines whether one or more conditions for transferring data from the base station to the UE using MT-SDT have been configured (block 404).

Further, the UE performing at least one of: (i) upon determining that the one or more conditions have not been configured, transmitting, by the UE, an uplink (UL) response message to the base station indicating an initiation of MT-SDT, and receiving, by the UE, data from the base station using MT-SDT, (ii) upon determining that the one or more conditions have been configured and that the one or more configured conditions have been satisfied, transmitting, by the UE, the UL response message to the base station indicating the initiation of MT-SDT, and receiving, by the UE, data from the base station using MT-SDT, or (iii) upon determining that the one or more conditions have been configured and that at least one of the one or more configured conditions has not been satisfied, receiving, by the UE, data from the base station in an RRC_CONNECTED state (block 406).

In some implementations, the one or more conditions can include a first condition pertaining to a radio quality of wireless signals received by the UE from the base station. In some implementations, the first condition is satisfied when a Reference Signal Received Power (RSRP) of the wireless signals is greater than a threshold value.

In some implementations, the one or more conditions can include a second condition pertaining to at least one of a radio bearer or a radio service for transmitting data between the base station and the UE. In some implementations, the second condition is satisfied upon the UE determining that one or more resource blocks (RBs) indicated by the base station are configured for MT-SDT.

In some implementations, the one or more conditions can include a third condition pertaining to a selection of a resource for transmitting the UL response message from the UE to the base station. In some implementations, the third condition can include selecting the resource from among: a legacy Random Access Channel (RACH) resource, a RACH resource specific to Small Data Transmission (SDT), and a Configured Grant (CG) resource specific to SDT.

In some implementations, the one or more conditions can be configured based on an RRC Release message transmitted from the base station to the UE.

In some implementations, the one or more conditions can be configured based on the MT-SDT paging message.

In some implementations, the first condition can be configured for both MT-SDT and Mobile Originated Small Data Transmission (MO-SDT).

In some implementations, the legacy RACH resource can be selected, and the legacy RACH resource can be different from one or more RACH resources specific to SDT.

In some implementations, the method 400 can be performed by a user equipment (UE).

In some implementations, the method 400 can be performed by at least one baseband processor.

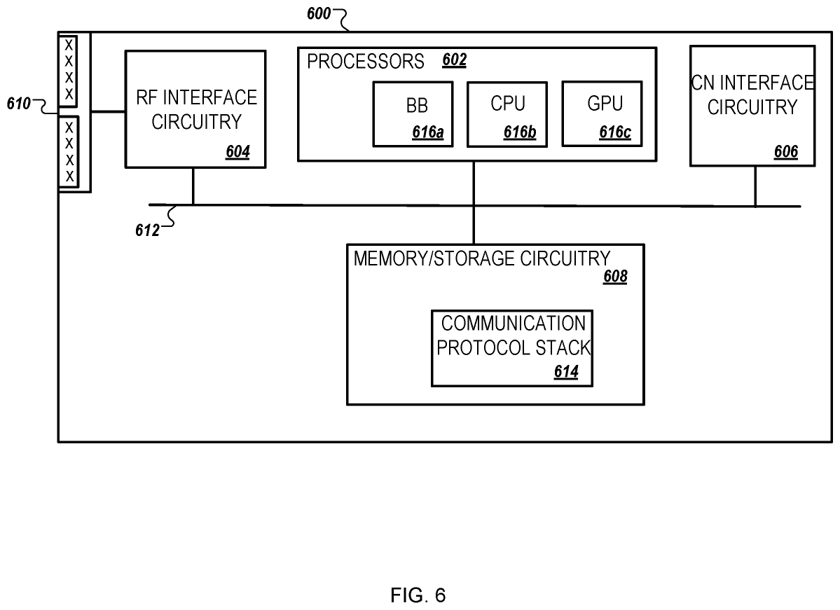

FIG. 4B illustrates a flowchart of an example method 420. For clarity of presentation, the description that follows generally describes method 420 in the context of the other figures in this description. For example, method 420 can be performed, at least in part, by the base station 104 and/or the access node 600 shown in FIGS. 1 and 6, respectively. It will be understood that method 420 can be performed, for example, by any suitable system, environment, software, hardware, or a combination of systems, environments, software, and hardware, as appropriate. In some implementations, various steps of method 420 can be run in parallel, in combination, in loops, or in any order.

According to the method 420, a base station receives data for transmission to a user equipment (UE), where the UE is in an RRC_INACTIVE state (block 422).

Further, the base station transmits, to the UE, a MT-SDT paging message (block 424).

Further, the base station performs at least one of: (i) upon receiving an uplink (UL) response message indicating an initiation of MT-SDT by the UE, transmitting the data to the UE using MT-SDT, or (ii) upon determining that the UE entered an RRC_CONNECTED State, transmitting the data to the UE in the RRC_CONNECTED state (block 426)

In some implementations, the method can also include transmitting, by the base station to the UE configuration information representing one or more conditions for transferring the data from the base station to the UE using MT-SDT.

In some implementations, at least a portion of the configuration information can be transmitted from the base station to the UE via an RRC Release message.

In some implementations, at least a portion of the configuration information can be transmitted from the base station to the UE via the MT-SDT paging message.

In some implementations, the one or more conditions can include a first condition pertaining to a radio quality of wireless signals received by the UE from the base station. In some implementations, the first condition is satisfied when a Reference Signal Received Power (RSRP) of the wireless signals is greater than a threshold value.

In some implementations, the one or more conditions can include a second condition pertaining to at least one of a radio bearer or a radio service for transmitting data between the base station and the UE. In some implementations, the second condition is satisfied upon the UE determining that one or more resource blocks (RBs) indicated by the base station are configured for MT-SDT.

In some implementations, the one or more conditions can include a third condition pertaining to a selection of a resource for transmitting the UL response message from the UE to the base station. In some implementations, the third condition can include selecting the resource from among: a legacy Random Access Channel (RACH) resource, a RACH resource specific to Small Data Transmission (SDT), and a Configured Grant (CG) resource specific to SDT.

In some implementations, the base station can transmit the MT-SDT paging message responsive to: determining a resource block (RB) associated with the data for transmission to the UE, and determining that the RB is configured for MT-SDT.

In some implementations, the first condition can be configured for both MT-SDT and Mobile Originated Small Data Transmission (MO-SDT).

In some implementations, the legacy RACH resource can be selected, and the legacy RACH resource can be different from one or more RACH resources specific to SDT.

In some implementations, the method 420 can be performed by a base station.

In some implementations, the method 420 can be performed by at least one baseband processor.

FIG. 4C illustrates a flowchart of an example method 440. For clarity of presentation, the description that follows generally describes method 440 in the context of the other figures in this description. For example, method 440 can be performed, at least in part, by the UE 102 and/or UE 500 shown in FIGS. 1 and 5, respectively. It will be understood that method 440 can be performed, for example, by any suitable system, environment, software, hardware, or a combination of systems, environments, software, and hardware, as appropriate. In some implementations, various steps of method 440 can be run in parallel, in combination, in loops, or in any order.

According to the method 440, a device receives, in an RRC_INACTIVE state, a paging message from a base station of a wireless network, the paging messaging including a Mobile Terminated Small Data Transmission (MT-SDT) indication (block 442).

The device determines whether one or more conditions for exchanging data with the base station using MT-SDT are satisfied (block 444).

The device transmits, in the RRC_INACTIVE state, an uplink (UL) response message to initiate the MT-SDT, based on a determination that the one or more conditions are satisfied (block 446).

In some implementations, the one or more conditions can include a first condition pertaining to a radio quality of wireless signals received from the base station.

In some implementations, the first condition can be satisfied when a Reference Signal Received Power (RSRP) of the wireless signals is greater than a threshold value.

In some implementations, the first condition can be configured for both MT-SDT and Mobile Originated Small Data Transmission (MO-SDT).

In some implementations, the one or more conditions can include a second condition pertaining to a selection of a resource for transmitting the UL response message to the base station.

In some implementations, the second condition can include selecting the resource from among: a legacy Random Access Channel (RACH) resource, a RACH resource specific to Small Data Transmission (SDT), and a Configured Grant (CG) resource specific to SDT.

In some implementations, the legacy RACH resource can be selected, and the legacy RACH resource can be different from one or more RACH resources specific to SDT.

In some implementations, the method can include determining that the first condition is not satisfied, and responsive to determining that the first conditions is not satisfied, initiating an RRC Resume procedure.

In some implementations, the UL response message can be transmitted using one or more resources selected based on a configuration received from the base station.

In some implementations, the configuration received from the base station can be a RRC specific configuration.

In some implementations, the configuration received from the base station can be a System Information Block (SIB) broadcast configuration.

FIG. 4D illustrates a flowchart of an example method 460. For clarity of presentation, the description that follows generally describes method 460 in the context of the other figures in this description. For example, method 460 can be performed, at least in part, by the base station 104 and/or the access node 600 shown in FIGS. 1 and 6, respectively. It will be understood that method 460 can be performed, for example, by any suitable system, environment, software, hardware, or a combination of systems, environments, software, and hardware, as appropriate. In some implementations, various steps of method 460 can be run in parallel, in combination, in loops, or in any order.

According to the method 460, a device transmits, to the UE in an RRC-INACTIVE state, a paging message including a Mobile Terminated Small Data Transmission (MT-SDT) indication (block 462).

Further, the device receives, from the UE in the RRC-INACTIVE state, an uplink (UL) response message initiating the MT-SDT, where the UL response message based on one or more conditions for exchanging data with the UE using the MT-SDT being satisfied (block 464).

In some implementations, the one or more conditions can include a first condition pertaining to a radio quality of wireless signals received by the UE.

In some implementations, the first condition can be satisfied when a Reference Signal Received Power (RSRP) of the wireless signals is greater than a threshold value.

In some implementations, the first condition can be configured for both MT-SDT and Mobile Originated Small Data Transmission (MO-SDT).

In some implementations, the one or more conditions can include a second condition pertaining to a selection of a resource by the EU for transmitting the UL response message.

In some implementations, the second condition can include selecting the resource from among: a legacy Random Access Channel (RACH) resource, a RACH resource specific to Small Data Transmission (SDT), and a Configured Grant (CG) resource specific to SDT.

In some implementations, the legacy RACH resource can be selected by the UE, and the legacy RACH resource can be different from one or more RACH resources specific to SDT.

In some implementations, the method can include receiving data for transmission to the UE, and transmitting the data to the UE using MT-SDT.

In some implementations, the method 460 can be performed by a base station.

In some implementations, the method 460 can be performed by at least one baseband processor.

### Example Systems and Devices:

FIG. 5 illustrates a UE 500, according to some implementations. The UE 500 may be similar to and substantially interchangeable with UE 102 of FIG. 1.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 510 and control and allow access to sensor circuitry 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

FIG. 6 illustrates an access node 600 (e.g., a base station or gNB), according to some implementations. The access node 600 may be similar to and substantially interchangeable with base station 104. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 5. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### FURTHER EXAMPLES

In the following sections, further exemplary embodiments are provided.

Example A1 includes a method comprising: receiving, by a user equipment (UE) in an RRC_INACTIVE state, a Mobile Terminated Small Data Transmission (MT-SDT) paging message from a base station of a wireless network; determining, by the UE, whether one or more conditions for transferring data from the base station to the UE using MT-SDT have been configured; and performing at least one of: (i) upon determining that the one or more conditions have not been configured, transmitting, by the UE, an uplink (UL) response message to the base station indicating an initiation of MT-SDT, and receiving, by the UE, data from the base station using MT-SDT, (ii) upon determining that the one or more conditions have been configured and that the one or more configured conditions have been satisfied, transmitting, by the UE, the UL response message to the base station indicating the initiation of MT-SDT, and receiving, by the UE, data from the base station using MT-SDT, or (iii) upon determining that the one or more conditions have been configured and that at least one of the one or more configured conditions has not been satisfied, receiving, by the UE, data from the base station in an RRC_CONNECTED state.

Example A2 includes the method of Example A1. Further, the one or more conditions comprises a first condition pertaining to a radio quality of wireless signals received by the UE from the base station.

Example A3 includes the method of Example A2. Further, the first condition is satisfied when a Reference Signal Received Power (RSRP) of the wireless signals is greater than a threshold value.

Example A4 includes the method of Example 3. Further, the first condition is configured for both MT-SDT and Mobile Originated Small Data Transmission (MO-SDT).

Example A5 includes the method of Example A1. Further, the one or more conditions comprises a second condition pertaining to at least one of a radio bearer or a radio service for transmitting data between the base station and the UE.

Example A6 includes the method of Example A5. Further, the second condition is satisfied upon the UE determining that one or more resource blocks (RBs) indicated by the base station are configured for MT-SDT.

Example A7 includes the method of Example A1. Further, the one or more conditions comprise a third condition pertaining to a selection of a resource for transmitting the UL response message from the UE to the base station.

Example A8 includes the method of Example A7. Further, the third condition comprises selecting the resource from among: a legacy Random Access Channel (RACH) resource, a RACH resource specific to Small Data Transmission (SDT), and a Configured Grant (CG) resource specific to SDT.

Example A9 includes method of Example A8. Further, the legacy RACH resource is selected, and the legacy RACH resource is different from one or more RACH resources specific to SDT.

Example A10 includes the method of Example A1. Further, the one or more conditions are configured based on an RRC Release message transmitted from the base station to the UE.

Example A11 includes the method of Example A1. Further, the one or more conditions are configured based on the MT-SDT paging message.

Example A12 includes the method of any of Examples A1-A11. Further, the method is performed by a UE.

Example A13 includes the method of any of Examples A1-A11. Further, the method is performed by a baseband processor.

Example B1 includes an apparatus comprising one or processors and one or more storage devices on which are stored instructions that are operable, when executed by the one or more processors, to cause the one or more processors to perform the method of any of Examples A1-A13.

Example B2 includes the apparatus of Example B1. Further, the apparatus is a baseband processor.

Example B3 includes the apparatus of Example B2. Further, the apparatus is a baseband processor.

Example C1 includes a non-transitory computer storage medium encoded with instructions that, when executed by one or more processors, cause the one or more processors to perform the method of any of Examples A1-A13.

Example D1 includes an apparatus comprising one or more baseband processors configured to perform the method of any of Example A1-A13.

Example E1 includes a method comprising: receiving, by a base station of a wireless network, data for transmission to a user equipment (UE), wherein the UE is in an RRC_INACTIVE state; transmitting, by the base station to the UE, a Mobile Terminated Small Data Transmission (MT-SDT) paging message; and performing at least one of: (i) upon receiving an uplink (UL) response message indicating an initiation of MT-SDT by the UE, transmitting the data to the UE using MT-SDT, or (ii) upon determining that the UE entered an RRC_CONNECTED State, transmitting the data to the UE in the RRC_CONNECTED state.

Example E2 includes the method of Example E1. Further, the method includes transmitting, by the base station to the UE configuration information representing one or more conditions for transferring the data from the base station to the UE using MT-SDT.

Example E3 includes the method of Example E2. Further, at least a portion of the configuration information is transmitted from the base station to the UE via an RRC Release message.

Example E4 includes the method of Example E2. Further, at least a portion of the configuration information is transmitted from the base station to the UE via the MT-SDT paging message.

Example E5 includes the method of Example E2. Further, the one or more conditions comprises a first condition pertaining to a radio quality of wireless signals received by the UE from the base station.

Example E6 includes the method of Example E5. Further, the first condition is satisfied when a Reference Signal Received Power (RSRP) of the wireless signals is greater than a threshold value.

Example E7, includes the method of Example E6. Further, the first condition is configured for both MT-SDT and Mobile Originated Small Data Transmission (MO-SDT).

Example E8 includes the method of Example E2. Further, the one or more conditions comprises a second condition pertaining to at least one of a radio bearer or a radio service for transmitting data between the base station and the UE.

Example E9 includes the method of Example E8. Further, the second condition is satisfied upon the UE determining that one or more resource blocks (RBs) indicated by the base station are configured for MT-SDT.

Example E10 includes the method of Example E2. Further, the one or more conditions comprises a third condition pertaining to a selection of a resource for transmitting the UL response message from the UE to the base station.

Example E11 includes the method of Example E10. Further, the third condition comprises selecting the resource from among: a legacy Random Access Channel (RACH) resource, a RACH resource specific to Small Data Transmission (SDT), and a Configured Grant (CG) resource specific to SDT.

Example E12 includes the method of Example E1. Further, the legacy RACH resource is selected, and the legacy RACH resource is different from one or more RACH resources specific to SDT.

Example E13 includes the method of Example E1. Further, the base station transmits the MT-SDT paging message responsive to: determining a resource block (RB) associated with the data for transmission to the UE, and determining that the RB is configured for MT-SDT.

Example E14 includes the method of any of Examples E1-E13. Further, the method is performed by a base station.

Example E15 includes the method of any of Examples E1-E13. Further, the method is performed by a baseband processor.

Example F1 includes an apparatus comprising one or processors and one or more storage devices on which are stored instructions that are operable, when executed by the one or more processors, to cause the one or more processors to perform the method of any of Examples E1-E11.

Example F2 includes the apparatus of Example F1. Further, the apparatus is a baseband processor.

Example F3 includes the apparatus of Example F1. Further, the apparatus is a base station.

Example G1 includes a non-transitory computer storage medium encoded with instructions that, when executed by one or more processors, cause the one or more processors to perform the method of any of Examples E1-E15.

Example H1 includes an apparatus comprising one or more baseband processors configured to perform the methods of any of claims Examples E1-E15.

Example H1 includes a method comprising: receiving, in an RRC_INACTIVE state, a paging message from a base station of a wireless network, the paging messaging comprising a Mobile Terminated Small Data Transmission (MT-SDT) indication; determining whether one or more conditions for exchanging data with the base station using MT-SDT are satisfied; and transmitting, in the RRC_INACTIVE state, an uplink (UL) response message to initiate the MT-SDT, based on a determination that the one or more conditions are satisfied.

Example H2 includes the method of Example H1. Further, the one or more conditions comprises a first condition pertaining to a radio quality of wireless signals received from the base station.

Example H3 includes the method of Example H2. Further, the first condition is satisfied when a Reference Signal Received Power (RSRP) of the wireless signals is greater than a threshold value.

Example H4 includes the method of Example H2. Further, the first condition is configured for both MT-SDT and Mobile Originated Small Data Transmission (MO-SDT).

Example H5 includes the method of Example H2. Further, the one or more conditions comprise a second condition pertaining to a selection of a resource for transmitting the UL response message to the base station.

Example H6 includes the method of Example H5. Further, the second condition comprises selecting the resource from among: a legacy Random Access Channel (RACH) resource, a RACH resource specific to Small Data Transmission (SDT), and a Configured Grant (CG) resource specific to SDT.

Example H7 includes the method of Example H6. Further, the legacy RACH resource is selected, and wherein the legacy RACH resource is different from one or more RACH resources specific to SDT.

Example H8 includes the method of Example H2. Further, the method comprises: determining that the first condition is not satisfied, and responsive to determining that the first conditions is not satisfied, initiating an RRC Resume procedure.

Example H9 includes the method of Example H1. Further, the UL response message is transmitted using one or more resources selected based on a configuration received from the base station.

Example H10 includes the method of Example E9. Further, the configuration received from the base station is a RRC specific configuration.

Example H11 includes the method of Example E9. Further, the configuration received from the base station is a System Information Block (SIB) broadcast configuration.

Example I1 includes an apparatus comprising one or processors and one or more storage devices on which are stored instructions that are operable, when executed by the one or more processors, to cause the one or more processors to perform the method of any of Examples H1-H11.

Example I2 includes the apparatus of Example I1. Further, the apparatus is a baseband processor.

Example I3 includes the apparatus of Example I1. Further, the apparatus is a UE.

Example J1 includes a non-transitory computer storage medium encoded with instructions that, when executed by one or more processors, cause the one or more processors to perform the method of any of Examples H1-H11.

Example K1 includes method comprising: transmitting, to the UE in an RRC-INACTIVE state, a paging message comprising a Mobile Terminated Small Data Transmission (MT-SDT) indication; and receiving, from the UE in the RRC-INACTIVE state, an uplink (UL) response message initiating the MT-SDT, based on one or more conditions for exchanging data with the UE using the MT-SDT being satisfied.

Example K2 includes the method of Example K1. Further, the one or more conditions comprises a first condition pertaining to a radio quality of wireless signals received by the UE.

Example K3 includes the method of Example K2. Further, the first condition is satisfied when a Reference Signal Received Power (RSRP) of the wireless signals is greater than a threshold value.

Example K4 includes the method of Example K2. Further, the first condition is configured for both MT-SDT and Mobile Originated Small Data Transmission (MO-SDT).

Example K5 includes the method of Example K2. Further, the one or more conditions comprise a second condition pertaining to a selection of a resource by the EU for transmitting the UL response message.

Example K6 includes the method of Example K5. Further, the second condition comprises selecting the resource from among: a legacy Random Access Channel (RACH) resource, a RACH resource specific to Small Data Transmission (SDT), and a Configured Grant (CG) resource specific to SDT.

Example K7 includes the method of Example K6. Further, the legacy RACH resource is selected by the UE, and wherein the legacy RACH resource is different from one or more RACH resources specific to SDT.

Example K8 includes the method of Example K1. Further, the method comprises: receiving data for transmission to the UE, and transmitting the data to the UE using MT-SDT.

Example K9 includes the method of any of Examples K1-K8. Further, the method is performed by a base station.

Example K10 includes the method of any of Examples K1-K8. Further, the method is performed by a baseband processor.

Example L1 includes an apparatus comprising one or processors and one or more storage devices on which are stored instructions that are operable, when executed by the one or more processors, to cause the one or more processors to perform the method of any of Examples K1-K10.

Example L2 includes the apparatus of Example L1. Further, the apparatus is a baseband processor.

Example L3 includes the apparatus of Example L1. Further, the apparatus is a base station.

Example M1 includes a non-transitory computer storage medium encoded with instructions that, when executed by one or more processors, cause the one or more processors to perform the method of any of Examples K1-K10.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1.-36. (canceled)

37. A method comprising:
receiving, in an RRC_INACTIVE state, a paging message from a base station of a wireless network, the paging messaging comprising a Mobile Terminated Small Data Transmission (MT-SDT) indication;
determining whether one or more conditions for exchanging data with the base station using MT-SDT are satisfied; and
transmitting, in the RRC_INACTIVE state, an uplink (UL) response message to initiate the MT-SDT, based on a determination that the one or more conditions are satisfied.

38. The method of claim 37, wherein the one or more conditions comprises a first condition pertaining to a radio quality of wireless signals received from the base station.

39. The method of claim 38, wherein the first condition is satisfied when a Reference Signal Received Power (RSRP) of the wireless signals is greater than a threshold value.

40. The method of claim 38, wherein the first condition is configured for both MT-SDT and Mobile Originated Small Data Transmission (MO-SDT).

41. The method of claim 38, wherein the one or more conditions comprise a second condition pertaining to a selection of a resource for transmitting the UL response message to the base station.

42. The method of claim 41, wherein the second condition comprises selecting the resource from among:
a legacy Random Access Channel (RACH) resource,
a RACH resource specific to Small Data Transmission (SDT), and
a Configured Grant (CG) resource specific to SDT.

43. The method of claim 42, wherein the legacy RACH resource is selected, and wherein the legacy RACH resource is different from one or more RACH resources specific to SDT.

44. The method of claim 38, further comprising:
determining that the first condition is not satisfied, and
responsive to determining that the first conditions is not satisfied, initiating an RRC Resume procedure.

45. The method of claim 37, wherein the UL response message is transmitted using one or more resources selected based on a configuration received from the base station.

46. The method of claim 45, wherein the configuration received from the base station is a RRC specific configuration.

47. The method of claim 45, wherein the configuration received from the base station is a System Information Block (SIB) broadcast configuration.

48. The method of claim 37, wherein the method is performed by a user equipment (UE).

49. The method of claim 37, wherein the method is performed by at least one baseband processor.

50.-66. (canceled)

67. A non-transitory computer storage medium encoded with instructions that, when executed by one or more processors, cause the one or more processors to perform operations comprising:
transmitting, to the UE in an RRC-INACTIVE state, a paging message comprising a Mobile Terminated Small Data Transmission (MT-SDT) indication; and
receiving, from the UE in the RRC-INACTIVE state, an uplink (UL) response message initiating the MT-SDT, based on one or more conditions for exchanging data with the UE using the MT-SDT being satisfied.

68. The non-transitory computer storage medium of claim 67, wherein the one or more conditions comprises a first condition pertaining to a radio quality of wireless signals received by the UE.

69. The non-transitory computer storage medium of claim 68, wherein the first condition is satisfied when a Reference Signal Received Power (RSRP) of the wireless signals is greater than a threshold value.

70. The non-transitory computer storage medium of claim 68, wherein the first condition is configured for both MT-SDT and Mobile Originated Small Data Transmission (MO-SDT).

71. The non-transitory computer storage medium of claim 68, wherein the one or more conditions comprise a second condition pertaining to a selection of a resource by the EU for transmitting the UL response message.

72. The non-transitory computer storage medium of claim 71, wherein the second condition comprises selecting the resource from among:
a legacy Random Access Channel (RACH) resource,
a RACH resource specific to Small Data Transmission (SDT), and
a Configured Grant (CG) resource specific to SDT.

73. An apparatus comprising one or more processors and one or more storage devices on which are stored instructions that are operable, when executed by the one or more processors, to cause the one or more processors to perform operations comprising:
receiving, in an RRC_INACTIVE state, a Mobile Terminated Small Data Transmission (MT-SDT) paging message from a base station of a wireless network;
determining whether one or more conditions for transferring data from the base station using MT-SDT have been configured; and
performing at least one of:
(i) upon determining that the one or more conditions have not been configured, transmitting an uplink (UL) response message to the base station indicating an initiation of MT-SDT, and receiving data from the base station using MT-SDT,
(ii) upon determining that the one or more conditions have been configured and that the one or more configured conditions have been satisfied, transmitting the UL response message to the base station indicating the initiation of MT-SDT, and receiving data from the base station using MT-SDT, or
(iii) upon determining that the one or more conditions have been configured and that at least one of the one or more configured conditions has not been satisfied, receiving data from the base station in an RRC_CONNECTED state.
